(19) United States
(12) Patent Application Publication
(10) Pub. No.: US 2009/0067368 A1
(43) Pub. Date: Mar. 12, 2009

(54) Method and Apparatus for Selecting a Radio Access Technology for Communication

(76) Inventors: Michael Patrick McAndrews, Kitchener (CA); Mihal Lazaridis, Waterloo (CA); Mark E. Pecen, Waterloo (CA); Hugh Hind, Waterloo (CA)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(21) Appl. No.: 11/844,676

(22) Filed: Aug. 24, 2007

(51) Int. Cl. H04W 4/00

(52) U.S. Cl. 370/328; 455/500

(57) ABSTRACT

A method and apparatus for communicating data between a mobile communication device and a communications node via an appropriate radio access technology. In one embodiment, the method comprises identifying at least one characteristic associated with data pending for communication, identifying a set of radio access technologies available for communication and at least one characteristic of each, evaluating the characteristics of the pending data relative to the characteristics of the available radio access technologies, selecting from the set of available radio access technologies a radio access technology relative to the pending data and effectuating communication of at least a portion of the pending data via a communication link employing the selected radio access technology.

### TECHNICAL FIELD OF THE APPLICATION

The present disclosure generally relates to wireless packet data service networks. More particularly, and not by way of any limitation, the present disclosure is directed to a mobile communication device and related data service network capable of communicating via at least two radio access technologies and incorporating an interface operable to select an appropriate radio access technology according to the nature of the communication.

### BACKGROUND

The present disclosure is directed toward the wireless transmission of electronic data, which may include electronic messages, digital images, audio files or video files, as examples. The characteristics and transmission requirements of electronic data may vary widely depending on the type of data. Because of these different characteristics, a given wireless communication mode or protocol may be more appropriate for some data types than it is for others. For certain types of data, for example, low latency may be important. For other types of data, high bandwidth may be necessary in order to transmit the data to the recipient within a reasonable time. Certain types of data may require low latency and high bandwidth, while others may require neither low latency nor high bandwidth.

### BRIEF DESCRIPTION OF THE DRAWINGS

A more complete understanding of the embodiments of the present disclosure may be had by reference to the following Detailed Description when taken in conjunction with the accompanying drawings wherein:

FIG. 1 depicts an exemplary network environment including one or more wireless packet data service networks wherein an embodiment of the present disclosure may be practiced;

FIG. 2 depicts a software architectural view of a mobile communication device operable to facilitate appropriate wireless data communication according to one embodiment;

FIG. 3 depicts a block diagram of a mobile communication device operable to facilitate appropriate wireless data communication according to one embodiment;

FIG. 4 depicts a flowchart of a process for communicating data via an appropriate radio access technology; and

FIG. 5 depicts a message flow diagram of a process for downlink communication via an appropriate radio access technology.

### DETAILED DESCRIPTION OF THE DRAWINGS

A system and method of the present disclosure will now be described with reference to various examples of how the embodiments can best be made and used. Identical reference numerals are used throughout the description and several views of the drawings to indicate identical or corresponding parts, wherein the various elements are not necessarily drawn to scale.

According to a first aspect, the present disclosure is directed to a method of communicating data between a mobile communication device and a communications node via an appropriate radio access technology. The method comprises identifying at least one characteristic associated with data pending for communication, identifying a set of radio access technologies available for communication and at least one characteristic of each, evaluating the characteristics of the pending data relative to the characteristics of the available radio access technologies, selecting from the set of available radio access technologies a radio access technology relative to the pending data and effectuating communication of at least a portion of the pending data via a communication link employing the selected radio access technology.

In certain embodiments, at least one characteristic of the radio access technology may relate to one of bandwidth, latency, cost and power consumption in any combination. The set of radio access technologies available to the mobile communication device may include one or more of General Packet Radio Service (GPRS), Enhanced Data Rates for GSM Evolution (EDGE), High-Speed Downlink Packet Access (HSDPA), High-Speed Uplink Packet Access (HSUPA), Integrated Digital Enhanced Network (IDEN), Universal Mobile Telephone System (UMTS), High Rate Packet Data Air Interface Evolution-Data Optimized (EVDO), Wi-Fi, Wi-Max, Bluetooth and so on. The selected appropriate radio access technology may be any one of these technologies. The communication link may be a downlink to the mobile communication device or an uplink to the communications node. The method may further include receiving input from a user as to which radio access technology to employ. The method may further include the terminating a communication path employing the appropriate radio access technology upon completion of the communication of the data.

According to a second aspect, the present disclosure relates to a mobile communication device operable to communicate data with a communications node via an appropriate radio access technology. The mobile communication device comprises means for identifying at least one characteristic associated with data pending for communication, means for identifying a set of radio access technologies available for communication and at least one characteristic of each, means for evaluating the characteristics of the pending data relative to the characteristics of the available radio access technologies, means for selecting from the set of available radio access technologies a radio access technology relative to the pending data and means for effectuating communication of at least a portion of the pending data via a communication link employing the selected radio access technology.

According to a third aspect, the present disclosure relates to a computer-readable medium having program code thereon for execution by a mobile communication device operable to communicate data with a communications node via an appropriate radio access technology. The program code comprises a code segment for identifying at least one characteristic associated with data pending for communication, a code segment for identifying a set of radio access technologies available for communication and at least one characteristic of each, a code segment for evaluating the characteristics of the pending data relative to the characteristics of the available radio access technologies, a code segment for selecting from the set of available radio access technologies a radio access technology relative to the pending data and a code segment for effectuating communication of at least a portion of the pending data via a communication link employing the selected radio access technology.

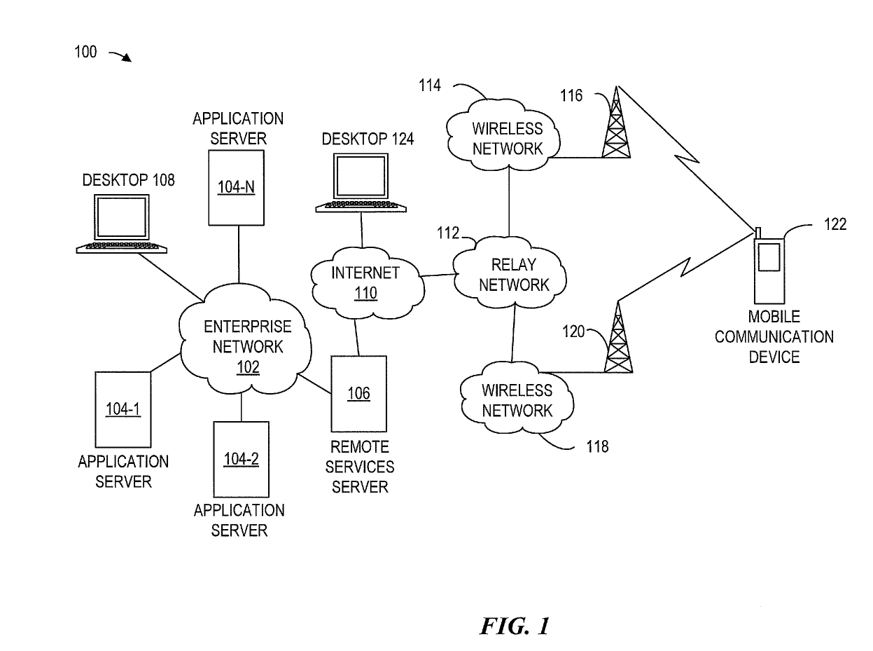

Referring now to the drawings, and more particularly to FIG. 1, depicted therein is an exemplary network environment 100 including one or more wireless packet data service networks wherein an embodiment of the present system may be practiced. As illustrated, an enterprise network 102, which may be a packet-switched network, can include one or more geographic sites and may be organized as a local area network (LAN), wide area network (WAN) or metropolitan area network (MAN), et cetera, for serving a plurality of corporate users. At the outset, it should be appreciated that although the network environment 100 is exemplified with an enterprise network 102 for purposes of illustration, the teachings set forth herein may be practiced in network environments without an enterprise network 102.

A number of application servers 104-1 through 104-N disposed as part of the enterprise network 102 are operable to provide or effectuate a host of internal and external services such as email, video mail, internet access, corporate data access, messaging, calendaring and scheduling, information management, and the like. Additionally, a remote services server 106 may be interfaced with the enterprise network 102. A single desktop computer 108 is shown connected to enterprise network 102, but those of skill in the art will appreciate that a diverse array of devices, including but not limited to desktop computers, laptop computers, palmtop computers, et cetera, although not specifically shown in FIG. 1, may be operably networked to one or more of the application servers 104-i, i=1, 2 . . . , N, with respect to the services supported within enterprise network 102.

Remote services server 106 may be interfaced with the enterprise network 102 for enabling a corporate user to access or effectuate any of the services from a remote location. A secure communication link with end-to-end encryption may be established that is mediated through an external IP network, i.e., a public packet-switched network such as the internet 110. In network 100, internet 110 connects remote services server 106 to a trusted network such as relay network 112, although it is not necessary in other embodiments.

Trusted relay network 112 may be disposed between the internet 110 and the infrastructure of wireless packet data service networks 114, 118, although it may be independent or otherwise distributed in other embodiments. By way of example, mobile communication device 122 may be a data-enabled handheld device capable of receiving and sending messages, web browsing, interfacing with corporate application servers, et cetera. As will be set forth in detail below, mobile communication device 122 may interface with various access infrastructure elements (e.g., base stations 116, 120) for purposes of effectuating communications over the wireless networks 114 and/or 118 using applicable radio access technologies.

A single desktop computer 124 is shown connected to internet 110 for purposes of illustration. Those of skill in the art will appreciate that millions of devices are in fact connected to the internet 110, as discussed above with respect to enterprise network 102. These include, but are not limited to, desktop computers, laptop computers, palmtop computers, cellular telephones, personal digital assistants and other mobile communication devices.

For purposes of the present disclosure, the wireless packet data service networks 116, 120 may be implemented in any known or heretofore unknown mobile communications technologies and network protocols. For instance, either of wireless packet data service networks 114, 118 may be comprised of a General Packet Radio Service (GPRS) network that provides a packet radio access for mobile devices using the cellular infrastructure of a Global System for Mobile Communications (GSM)-based carrier network. In other implementations, either of wireless packet data service networks 114, 118 may comprise an Enhanced Data Rates for GSM Evolution (EDGE) network, an Integrated Digital Enhanced Network (IDEN), a Code Division Multiple Access (CDMA) network, General Packet Radio Service (GPRS), Universal Mobile Telephone System (UMTS), High Rate Packet Data Air Interface Evolution-Data Optimized (EVDO), Wi-Fi, Wi-Max, Bluetooth or any 3rd Generation (3G) or post-3G network. Either or both of networks 114, 118 may incorporate High-Speed Downlink Packet Access (HSDPA) and/or High-Speed Uplink Packet Access (HSUPA) technology. Although these are provided as examples, those skilled in the art should readily recognize that the scope of the present disclosure is not limited thereby.

In FIG. 1, the data path comprising wireless network 114 and base station 116 and the data path comprising wireless network 118 and base station 120 are illustrative of multiple radio links that mobile communication device 122 may select for purposes of effectuating communication. The two data paths are represented in this manner for purposes of illustration, but those of skill in the art will recognize that the two paths may overlap sometimes, wherein certain components may be shared. The distinction between the two data paths is that there is some parameter distinguishing the two, which may comprise a different physical location or a different communications technology. One data path may, for example, be a GPRS path while the other is a Wi-Fi channel. The two data paths may, however, be distinct channels of the same technology having different qualities of service. One wireless data path may be a default data path associated with mobile communication device 122. In certain embodiments, this default data path will generally be established whenever mobile communication device 122 is active.

In certain embodiments, a second data path may only be established when there is a need for a specific quality of service not provided by the default data path. The default data path may be a low-cost, low-bandwidth communications path suitable for electronic messages and similar traffic, while a second data path may provide a higher-bandwidth limited availability communications path. This path may be provided by means of a different radio access technology, or it may be provided by means of the same radio access technology as the default data path. As noted, those of skill in the art will appreciate that reference to first and second data paths (or communication links) is to be understood in the context of the communications system within which mobile communication device 122 is operating. In certain embodiments, the first and second data paths may represent virtual private networks.

As noted above, the second data path may be a temporary data path established when, and for so long as, a supplemental data path is necessary for communication of a substantial amount of data. The characteristics of the second data path will vary by implementation. If mobile communication device 122 is multihomed, it may create an additional higher QoS PDP context in order to acquire a public IP address, or it may be implemented via ad hoc Wi-Fi networks. In certain embodiments, the second data path may be a virtual private network (VPN) as alluded to previously. Where the first data path is a secure encrypted data path, the second data path may employ the same encryption keys as the first data path. These and other variations are well within the knowledge of one of ordinary skill in the art.

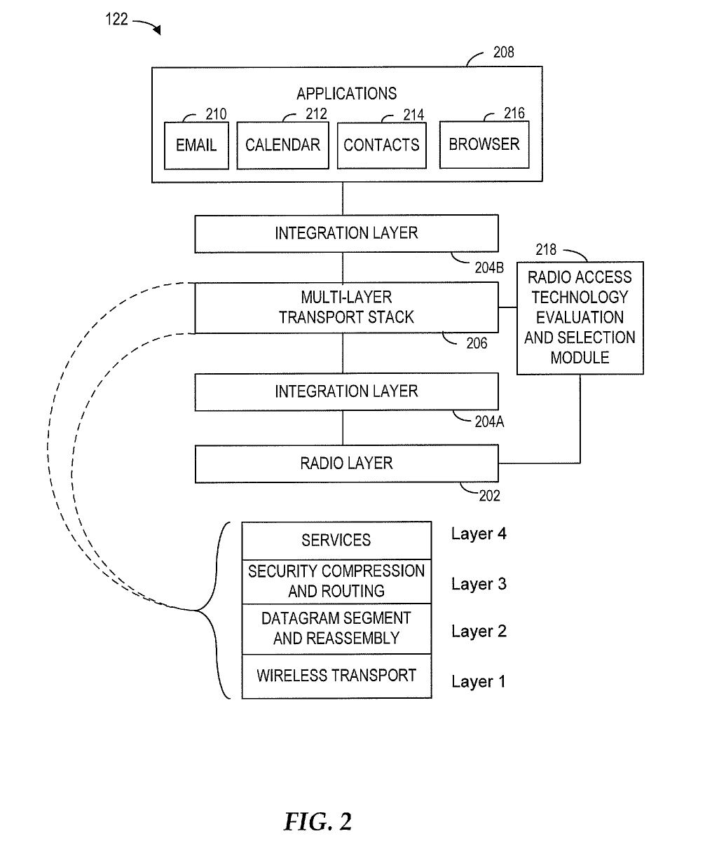

FIG. 2 depicts a software architectural view of mobile communication device 122 according to one embodiment. A multi-layer transport stack (TS) 206 is operable to provide a generic data transport protocol for a wide variety of data types, including email, via a reliable, secure and seamless continuous connection to a wireless packet data service network. As illustrated in this embodiment, an integration layer 204A is operable as an interface between the radio layer 202 and the transport stack 206 of mobile communication device 122. Likewise, another integration layer 204B is provided for interfacing between the transport stack 206 and the user applications 208 supported on the mobile communication device 122, e.g., email 210, calendar/scheduler 212, contact management 214 and browser 216. Although not specifically shown, the transport stack 206 may also be interfaced with the operating system of mobile communication device 122. In another implementation, the transport stack 206 may be provided as part of a data communications client module operable as a host-independent virtual machine on a mobile device. A radio access technology evaluation and selection module 218 is operably connected to transport stack 206 and radio layer 202 in order to evaluate, select, establish and maintain the appropriate wireless link(s) for the type of data being communicated at any given point in time. Although this functionality is represented as a single module, it should be appreciated that the various operations set forth herein and attributed to the radio access technology selection module 218 may be accomplished via a number of means, including software (e.g., program code), firmware, hardware, or in any combination, usually in association with a processing system. Where the processes are embodied in software, such software may comprise program instructions that form a computer program product, instructions on a computer readable medium, uploadable service application software, or software downloadable from a remote station, and the like.

The bottom layer (Layer 1) of the transport stack 206 is operable as an interface to the wireless network's packet layer. Layer 1 handles basic service coordination within the exemplary network environment 100 shown in FIG. 1. For example, when a mobile communication device roams from one carrier network to another, Layer 1 verifies that the packets are relayed to the appropriate wireless network and that any packets that are pending from the previous network are rerouted to the current network. The top layer (Layer 4) exposes various application interfaces to the services supported on the mobile communication device. The remaining two layers of the transport stack 206, Layer 2 and Layer 3, are responsible for datagram segmentation/reassembly and security, compression and routing, respectively. The radio layer 202 may employ one or more of a plurality of mobile communication technologies or RATs (which may include GPRS, EVDO, UMTS, HSDPA, Wi-fi, Bluetooth, WiMAX and the like).

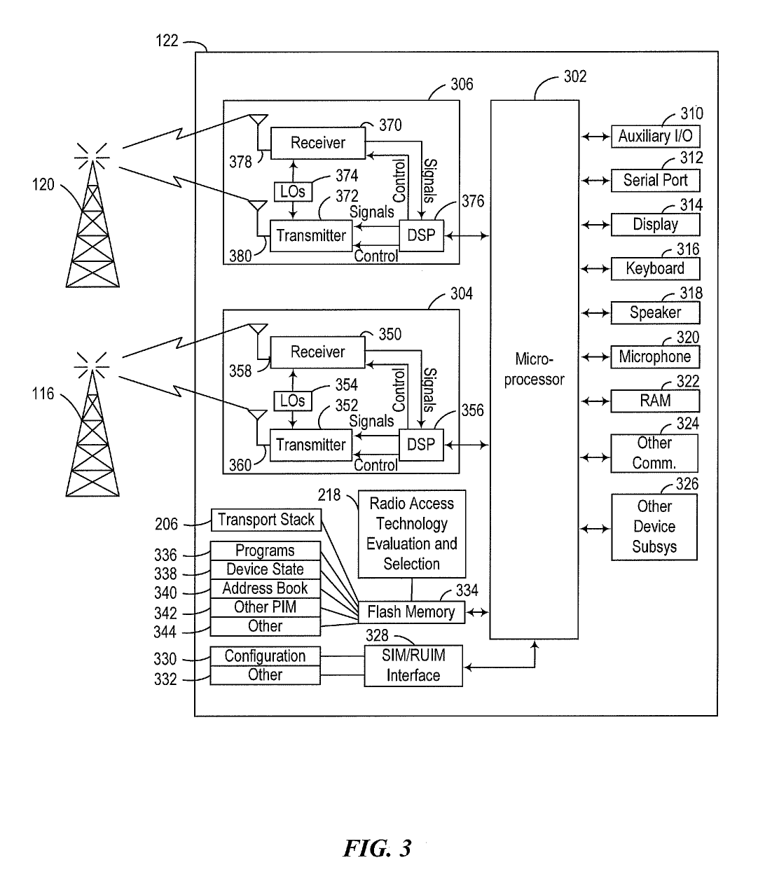

FIG. 3 depicts a block diagram of a mobile communication device 122 according to one embodiment. It will be recognized by those skilled in the art upon reference hereto that although an embodiment of mobile communication device 122 may comprise an arrangement similar to one shown in FIG. 3, there can be a number of variations and modifications, in hardware, software or firmware, with respect to the various modules depicted. Accordingly, the arrangement of FIG. 3 should be taken as illustrative rather than limiting with respect to the embodiments of the present disclosure.

A microprocessor 302 providing for the overall control of an embodiment of mobile communication device 122 is operably coupled to communication subsystems 304 and 306. Microprocessor 302 also interfaces with further device subsystems such as auxiliary input/output (I/O) 310, serial port 312, display 314, keyboard 316, speaker 318, microphone 320, random access memory (RAM) 322, a short-range communications subsystem 324, and any other device subsystems generally labeled as reference numeral 326. To control access, a Subscriber Identity Module (SIM) or Removable User Identity Module (RUIM) interface 328 is also provided in communication with the microprocessor 302.

In one implementation, SIM/RUIM interface 328 is operable with a SIM/RUIM card having a number of key configurations 330 and other information 332 such as identification and subscriber-related data. Operating system software and transport stack software may be embodied in a persistent storage module (i.e., non-volatile storage) such as flash memory 334. In one implementation, flash memory 334 may be segregated into different areas, e.g., storage area for computer programs 336 as well as data storage regions such as device state 338, address book 340, other personal information manager (PIM) data 342, and other data storage areas generally labeled as reference numeral 344. Radio access technology selection module 218 is operably connected to flash memory 336, whereby appropriate selection logic may be exercised in association with microprocessor 302.

Communication subsystem 304 includes a receiver 350 and transmitter 352 as well as associated components such as one or more local oscillator (LO) modules 354 and a processing module such as a digital signal processor 356. Finally, communication subsystem 304 includes receiver antenna 358 and transmitter antenna 360.

Communication subsystem 306 is shown having an identical design to communication subsystem 304, including a receiver 370 and transmitter 372 as well as associated components such as one or more local oscillator (LO) modules 374 and a processing module such as a digital signal processor 376. Finally, communication subsystem 306 includes receiver antenna 378 and transmitter antenna 380. As will be apparent to those skilled in the field of communications, the particular design of the communication modules 304, 306 may be dependent upon the communications networks and access technologies with which the mobile communication device 122 is intended to operate.

In certain embodiments, communication modules 304, 306 are each operable to transmit both voice and data communications. Regardless of the particular design, L however, signals received by antennas 358, 378 from base stations 116, 120 are provided to receivers 350, 370, which may perform such common receiver functions as signal amplification, frequency down conversion, filtering, channel selection, analog-to-digital (A/D) conversion, and the like. Similarly, signals to be transmitted via antennas 360, 380 are processed, including modulation and encoding, for example, by digital signal processors 356, 376, and provided to transmitters 352, 372 for digital-to-analog (D/A) conversion, frequency up conversion, filtering, amplification and transmission over the air-radio interface via antennas 360, 380.

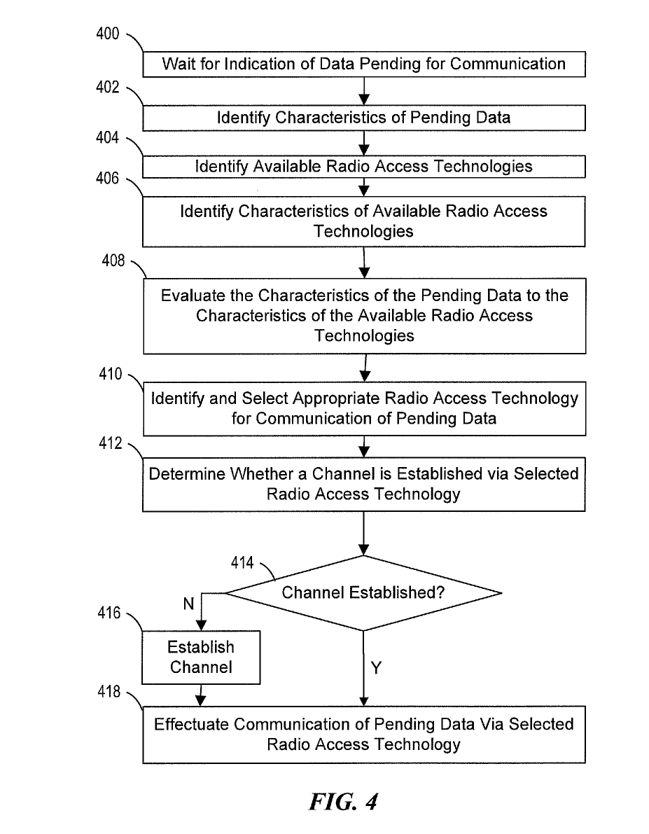

The manner of operation of the embodiments shown in FIGS. 2 and 3 is depicted in flowchart form in FIG. 4. Process flow begins in block 400, wherein the process waits for indication of data pending for communication. Upon indication of pending data, the characteristics related to the pending data are identified in block 402. These characteristics may include, for example, type of application data, size of data packets and the like. Once the characteristics of the pending data are identified, process flow proceeds to block 404, wherein the radio access technologies available for communication are identified.

In block 406, the communication characteristics of the available radio access technologies are identified. These characteristics may include, for example, bandwidth, latency, cost, power consumption, quality of service and so on. The characteristics of the pending data are then evaluated relative to the characteristics of the available radio access technologies in block 408. An appropriate radio access technology is then identified and selected in block 410 from the set of available radio access technologies based on the evaluation of the characteristics of the data to be communicated and the characteristics of the various radio access technologies available.

In block 412, an inquiry is made as to whether a communication channel or path is already established via the selected appropriate radio access technology. Process flow from decision block 414 depends on the outcome of the inquiry in block 412. If a channel or path is already established via the selected appropriate radio access technology, process flow proceeds directly to block 418. If a channel or path is not already established via the selected appropriate radio access technology, process flow proceeds to block 416, wherein a channel or path is established, and then on to block 418. In block 418, communication of the pending data is effectuated via the selected appropriate radio access technology.

Alternate embodiments may include more or fewer steps, as necessary for a particular application. In certain embodiments, the user of the mobile communication device may be given the option to select between two or more available radio access technologies. This may be useful, for example, where a less-appropriate technology is available free of charge or at a low cost and a more appropriate technology is available at a higher cost. Similarly, in situations where an appropriate radio access technology is identified but there is not an existing channel established having that technology, the user may be queried before a new channel is established, in order to optimize resource usage according to user preference.

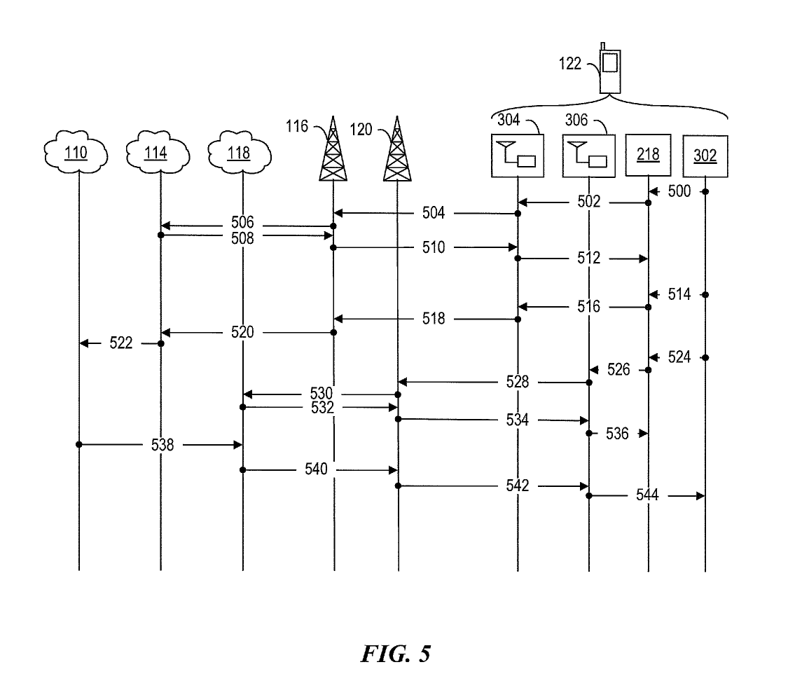

FIG. 5 depicts a message flow diagram of the process of establishing a first data path and a second data path. The process begins when microprocessor 302 becomes aware of data pending for communication. Upon receipt of this information, microprocessor 302 initiates a handshaking operation between mobile communication device 122 and wireless network 114. As seen in FIG. 5, this process is initiated by message 500 from microprocessor 302 to radio access technology selection module 218. Based on information received from microprocessor 302 and information available regarding available wireless networks 114 and 118, radio access technology selection module 218 selects wireless network 114 for communication of the pending data and determines that communication subsystem 304 should be employed for this communication.

The handshaking operations conducted in order to set up the first communication path are represented by messages 502-512. As seen in FIG. 5, the first leg of the handshaking process includes message 502 from radio access technology selection module 218 to communication subsystem 304, message 504 from communication subsystem 304 to base station 116, message 506 from base station 116 to wireless network 114. The response from wireless network 114 is represented by message 508 from wireless network 114 to base station 116, message 510 from base station 116 to communication subsystem 304 and message 512 from communication subsystem 304 to radio access technology selection module 218.

Once the first communication path is established, it is available for communication between mobile communication device 122 and another network entity, such as a node within internet 110. An exemplary data transfer between mobile communication device 122 and internet 110 is represented in FIG. 5 by messages 514-522. Specifically, these messages include message 514 from microprocessor 302 to radio access technology selection module 218, message 516 from radio access technology selection module 218 to communication subsystem 304, message 518 from communication subsystem 304 to base station 116, message 520 from base station 116 to wireless network 114 and message 522 from wireless network 114 to internet 110. Data transfers of the type represented by messages 514-522 can be conducted as necessary so long as the first data path is established. Although messages 514-522 represent a single communication from mobile communication device 122 to internet 110, those of skill in the art will appreciate that communication between mobile communication device 122 and internet 110 will generally include a large number of communications in both directions.

At some point in time subsequent to the handshaking operations represented by messages 500-512 and the communications represented in part by messages 514-522, microprocessor 302 becomes aware of additional data pending for communication and determines that there is a need for a communication path having different characteristics than the first communication path. The first communication path may, for example, be a low-bandwidth data path, or may be a high-latency data path, or it may have some other characteristic rendering it less than ideal for communication of the pending data.

Based upon the characteristics of the pending data and the characteristics of wireless networks 114 and 118, microprocessor 302 determines that wireless network 118 with its associated radio access technology would be appropriate for communication of the pending data. There are a number of reasons why wireless network 118 might be preferable to wireless network 114 for the additional pending data. Wireless network 118 might, for example, be operable to provide a higher-bandwidth channel or communication path via an appropriate radio access technology not available via wireless network 114. In certain embodiments, mobile communication device 122 may automatically initiate communication via a selected appropriate radio technology on demand. In certain other embodiments, mobile communication device 122 may present to the user a list of options as to available radio access technologies and await user instructions. The user may be presented, for example, with a first technology having a higher bandwidth and a second technology having a lower cost. In the event that no currently-available radio access technology is acceptable, the user may be presented with the option to delay download of a sizeable file until such time as a preferred radio access technology is available.

Once the appropriate radio access technology is selected, handshaking between mobile communication device 122 and wireless network 118 takes place as represented by messages 524-536. Specifically, the outgoing portion of this handshaking process includes message 524 from microprocessor 302 to radio access technology selection module 218, message 526 from radio access technology selection module 218 to communication subsystem 306, message 528 from communication subsystem 306 to base station 120 and message 530 from base station 120 to wireless network 118. The response by wireless network 118 is represented by message 532 from wireless network 118 to base station 120, message 534 from base station 120 to communication subsystem 306 and message 536 from communication subsystem 306 to radio access technology selection module 218.

Once the communication path is established between mobile communication device 122 and wireless network 118, a download can be effectuated from the internet 110 to the mobile communication device 122 over the communication path. The download is represented by messages 538-544, which include message 538 from internet 110 to wireless network 118, message 540 from wireless network 118 to base station 120, message 542 from base station 120 to communication subsystem 306 and message 544 from communication subsystem 306 to microprocessor 302. Although messages 538-544 represent a single communication from internet 110 to mobile communication device 122, those of skill in the art will appreciate that communication between mobile communication device 122 and internet 110 will generally include a large number of communications in both directions.

Based on the foregoing, it will be realized that the teachings set forth herein may be applied in a number of scenarios wherein data traffic may be steered to appropriate radio access technologies based on the type of application, for example, email, streaming media, web browsing, et cetera. Further, in another implementation, the data traffic may be steered based on other factors such as the actual size of the data packets, the time-sensitivity of the data (with appropriate timestamping and timer mechanisms), transmission costs, and the like.

It is believed that the operation and construction of the embodiments of the present disclosure will be apparent from the Detailed Description set forth above. While the exemplary embodiments shown and described may have been characterized as being preferred, it should be readily understood that various changes and modifications could be made therein without departing from the scope of the present disclosure as set forth in the following claims.

What is claimed is:

1. A method of communicating data between a mobile communication device and a communications node via an appropriate radio access technology, the method comprising:
identifying at least one characteristic associated with data pending for communication;
identifying a set of radio access technologies available for communication and at least one characteristic of each;
evaluating the characteristics of the pending data relative to the characteristics of the available radio access technologies;
selecting from the set of available radio access technologies a radio access technology relative to the pending data; and
effectuating communication of at least a portion of the pending data via a communication link employing the selected radio access technology.

2. The method as recited in claim 1, wherein the at least one characteristic of the set of radio access technologies is one of bandwidth, latency, cost and power consumption.

3. The method as recited in claim 1, wherein the set of radio access technologies available to the mobile communication device includes one or more of General Packet Radio Service (GPRS), Enhanced Data Rates for GSM Evolution (EDGE), High-Speed Downlink Packet Access (HSDPA), High-Speed Uplink Packet Access (HSUPA), Integrated Digital Enhanced Network (IDEN), Universal Mobile Telephone System (UMTS), High Rate Packet Data Air Interface Evolution, Data-Optimized (EVDO), Wi-Fi, Wi-Max and Bluetooth.

4. The method as recited in claim 1, wherein the communication link is a downlink to the mobile communication device.

5. The method as recited in claim 1, wherein the communication link is an uplink to a communications node.

6. The method as recited in claim 1, further comprising: receiving input from a user as to which radio access technology to employ.

7. The method as recited in claim 1, further comprising: terminating the communication link upon completion of the communication of the data.

8. A mobile communication device operable to communicate data with a communications node via an appropriate radio access technology, the mobile communication device comprising:
means for identifying at least one characteristic associated with data pending for communication;
means for identifying a set of radio access technologies available for communication and at least one characteristic of each;
means for evaluating the characteristics of the pending data relative to the characteristics of the available radio access technologies;
means for selecting from the set of available radio access technologies a radio access technology relative to the pending data; and
means for effectuating communication of at least a portion of the pending data via a communication link employing the selected radio access technology.

9. The mobile communication device as recited in claim 8, wherein the at least one characteristic of the set of radio access technologies is one of bandwidth, latency, cost and power consumption.

10. The mobile communication device as recited in claim 8, wherein the set of radio access technologies available to the mobile communication device includes one or more of General Packet Radio Service (GPRS), Enhanced Data Rates for GSM Evolution (EDGE), High-Speed Downlink Packet Access (HSDPA), High-Speed Uplink Packet Access (HSUPA), Integrated Digital Enhanced Network (IDEN), Universal Mobile Telephone System (UMTS), High Rate Packet Data Air Interface Evolution, Data-Optimized (EVDO), Wi-Fi, Wi-Max and Bluetooth.

11. The mobile communication device as recited in claim 8, wherein the communication link is a downlink to the mobile communication device.

12. The mobile communication device as recited in claim 8, wherein the communication link is an uplink to a communications node.

13. The mobile communication device as recited in claim 8, further comprising means for receiving input from a user as to which radio access technology to employ.

14. The mobile communication device as recited in claim 8, further comprising means for terminating the communication link upon completion of the communication of the data.

15. A computer-readable medium having program code thereon for execution by a mobile communication device operable to communicate data with a communications node via an appropriate radio access technology, the program code comprising:
a code segment for identifying at least one characteristic associated with data pending for communication;
a code segment for identifying a set of radio access technologies available for communication and at least one characteristic of each;
a code segment for evaluating the characteristics of the pending data relative to the characteristics of the available radio access technologies;
a code segment for selecting from the set of available radio access technologies a radio access technology relative to the pending data; and
a code segment for effectuating communication of at least a portion of the pending data via a communication link employing the selected radio access technology.

16. The computer readable medium as recited in claim 15, wherein the at least one characteristic of the set of radio access technologies is one of bandwidth, latency, cost and power consumption.

17. The computer readable medium as recited in claim 15, wherein the set of radio access technologies available to the mobile communication device includes one or more of General Packet Radio Service (GPRS), Enhanced Data Rates for GSM Evolution (EDGE), High-Speed Downlink Packet Access (HSDPA), High-Speed Uplink Packet Access (HSUPA), Integrated Digital Enhanced Network (IDEN), Universal Mobile Telephone System (UMTS), High Rate Packet Data Air Interface Evolution, Data-Optimized (EVDO), Wi-Fi, Wi-Max and Bluetooth.

18. The computer readable medium as recited in claim 15, wherein the communication link is a downlink to the mobile communication device.

19. The computer readable medium as recited in claim 15, further comprising a code segment for processing input from a user as to which radio access technology to employ.

20. The computer readable medium as recited in claim 15, further comprising a code segment for terminating the communication link upon completion of the communication of the data.
